(19) United States
(12) Patent Application Publication
(10) Pub. No.: US 2013/0091056 A1
(43) Pub. Date: Apr. 11, 2013

(54) SYSTEM AND METHOD FOR MAINTAINING AND CUSTOMIZING USER ACCOUNTS

(71) Applicants: Geoffrey Thomas, Needham, MA (US); Dan Goldman, Foxboro, MA (US)

(72) Inventors: Geoffrey Thomas, Needham, MA (US); Dan Goldman, Foxboro, MA (US)

(73) Assignee: CITIZENS FINANCIAL GROUP, INC., Providence, RI (US)

(21) Appl. No.: 13/309,671

(22) Filed: Dec. 2, 2011

Related U.S. Application Data
(60) Provisional application No. 61/544,773, filed on Oct. 7, 2011.

(51) Int. Cl. G06Q 40/02

(52) U.S. Cl. 705/42

(57) ABSTRACT

A system provides for a customer to maintain and customize a user account with a banking institution. A server maintains pre-established packages providing a group of services and applications providing a specific service. The server also maintains user accounts, each associated with a particular customer and with one or more services. The server processes requests to designate and customize packages and applications associated with a customer account. Graphical user interfaces (GUIs) are provided that allow for the customer to build, customize, and view the customer account. A selection GUI includes service icons associated with respective services and selectable by a customer to associate the respective services with the customer account. A customization GUI includes service windows that correspond to respective service icons, that include an overview summary of the respective services, and that are selectable to view and edit features of the respective services.

### REFERENCE TO RELATED APPLICATIONS

This application claims priority to U.S. Provisional Patent Application No. 61/544,773, entitled “Build Your Own,” filed on Oct. 7, 2011, the contents of which are included herein in their entirety.

### TECHNICAL FIELD

This application is directed to on-line user accounts. In particular, this application is directed to enabling a customer to maintain and customize a user account with a banking institution.

### BACKGROUND

Banking institutions may provide to customers a wide array of services and capabilities, which may be affiliated with user accounts associated with the customers. As the type and number of services and capabilities continue to expand, it becomes more desirable for a user to obtain, edit, and customize information with respect to those services and capabilities. At the same time, banking institutions wish to provide secure access to the offered services and capabilities, while also ensuring that customers are able to fully benefit from the offered services and capabilities.

Thus, there is a need for a banking institution to maintain user accounts while at the same time provide users with the ability to maintain and customize user accounts in a convenient, reliable, and secure manner.

### SUMMARY

A method for enabling a customer to maintain and customize a user account with a banking institution is provided. The method includes maintaining, at at least one server, at least one of one or more pre-established packages and one or more application, where each pre-established package provides a group of services and each application provides a specific service. The at least one server also maintains one or more user accounts, each user account associated with a particular customer, linked to a respective account registry indicating corresponding account information and customer information, and associated with one or more services. The method further includes processing at the at least one server a selection request from a customer to designate at least one of the one or more pre-established packages and the one or more applications to a specified account associated with the customer, and storing at the at least one server the specified account associated with the customer to incorporate into the specified account the services identified in the selection request. Each of the maintaining, processing, and storing steps are implemented by one or more processing devices that access instructions from one or more memory devices, the instructions, when executed, causing each of the maintaining, processing, and storing steps to be implemented.

A system for enabling a customer to maintain and customize a user account with a banking institution is provided. The system includes at least one server configured to communicate with one or more remote devices. The at least one server includes one or more processing devices that access instructions from one or more memory devices. When executed, the instructions cause the at least one server to maintain at least one of one or more pre-established packages and one or more applications, each pre-established package providing a group of services and each application providing a specific service. The server also maintains at least one user account, where each user account is associated with a particular customer, is linked to a respective account registry indicating corresponding account information and customer information, and is associated with one or more services. The server also processes a selection request received from a remote device to designate at least one of the one or more pre-established packages and the one or more applications to a specified account associated with the customer, and the server stores the specified account associated with the customer to incorporate into the specified account the services identified in the selection request

A system of one or more processing devices for providing one or more graphical user interfaces (GUIs) that enable customers of a banking institution to build, customize, and view accounts is provided. The system includes a selection GUI and a customization GUI. The selection GUI includes one or more service icons that are each associated with a respective service. At least one of the one or more service icons is selectable by a customer to associate the respective services with a specified account associated with the customer. The customization GUI includes one or more service windows, each corresponding to a respective service icon selectable by the customer for association with the specified account associated with the customer. Each service window includes an overview summary of the respective service and is selectable to view and edit features of the respective service.

A method of providing one or more graphical user interfaces (GUIs) via one or more processing devices that enable customers of a banking institution to build, customize, and view accounts is provided. The method includes providing a selection GUI and providing a customization GUI. The selection GUI includes one or more service icons, each of which are associated with a respective service and where at least one of the one or more service icons is selectable by a customer to associate the respective services with a specified account associated with the customer. The customization GUI is based on selections in the selection GUI and includes one or more service windows. Each service window corresponds to a respective service icon selectable by the customer for association with the specified account associated with the customer, includes an overview summary of the respective service, and is selectable to view and edit features of the respective service.

### BRIEF DESCRIPTION OF THE DRAWINGS

The foregoing summary and the following detailed description are better understood when read in conjunction with the appended drawings. Representative examples are shown in the drawings. However, it is understood that the examples are not limited to the specific methods and instrumentalities depicted herein. In the drawings:

FIG. 1 is a block diagram of a system according to an embodiment.

FIG. 2 is a diagram representing data maintained by the system according to an embodiment.

FIGS. 3a-3e are example interfaces providing a representation of available services according to an embodiment.

FIG. 4 is an example selection interface for selecting account features according to an embodiment.

FIGS. 5a-5i are example customization interfaces for customizing account features according to an embodiment.

FIG. 6 is an example recommendation interface for viewing recommended account features according to an embodiment.

FIGS. 7a-7g are example account creation interfaces according to an embodiment.

FIGS. 8a-8c are example verification interfaces for verifying selected account features according to an embodiment.

FIG. 9 is a flowchart illustrating a method for enabling a customer to maintain and customize a user account with a banking institution.

FIG. 10 is a flowchart illustrating a method of providing one or more graphical user interfaces (GUIs) that enable customers of a banking institution to build, customize, and view accounts.

### DETAILED DESCRIPTION

Banking institutions provide customers with accounts, such as checking accounts, credit card accounts, and savings accounts, for example. There are a multitude of types of services that may be affiliated with the accounts, such as online bill pay options, reward programs, and discount programs, for example. The types of services are endless and may vary depending on the banking institution and the customers, among other factors. A system operates to provide customers with the ability to customize their accounts as desired, including editing, adding, and removing services provided by the banking institution. The system further provides for account creation and maintenance, as well as other features as described below.

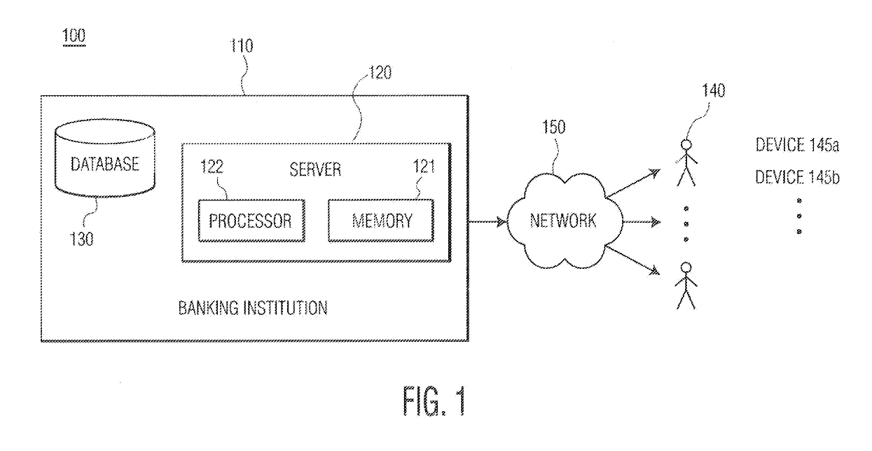

With reference to FIG. 1, a system 100 enabling a customer to maintain and customize a user account is provided. The system 100 includes at least one server 120 that is affiliated with a banking institution 110. The server 120 includes one or more processing devices 122 that access instructions from one or more memory devices 124 to perform operations that enable the maintenance and customization of user accounts. The term “server” as used herein should be broadly construed to include any device or devices capable of implementing and communicating processing instructions. The at least one server 120 may include communication interface elements for communication with other devices and components, internal and external to the banking institution 110. The term “processing device” as used herein, including the one or more processing devices 122, should be broadly construed and may each be a processing element embodied as a processor, a co-processor, a controller, or various other processing means or devices including integrated circuits. The term “memory device” as used herein, including the one or more memory devices 124, should be broadly construed and may each comprise volatile and/or non-volatile memory components, and the like, for storing and transferring various types of data, information, and instructions. A database 130 is also provided as part of the system 100 for storing user account information and other data and may include volatile and/or non-volatile memory components and the like. The server 120 may access data from the database 130 for processing thereof. Alternatively or additionally, the server 120 may communicate with remote memory elements stored on another server or the like.

The system 100 further includes one or more remote devices 145a-145n, through which one or more customers 140 may interact with the system 100. The one or more remote devices 145 may include, but are not limited to, mobile communication devices, landline telephones, cellular telephones, smart phones, personal digital assistants, computers, laptop computers, desk top computers, tablet computers, and the like. For instance, the one or more remote devices 145 may include an input interface through which the one or more customers 140 may interact over system 100, such as, for example, a keyboard, keypad, touchscreen, mouse, stylus, pointer, voice input, laser input or the like. In addition, the one or more remote devices 145 may include an output interface through which a user may access information over system 100, such as, for example, any type of visual indicators, including a display, a monitor, a screen or the like, as well as any suitable type of non-visual indicators or other devices for the visually impaired, including sound generating devices, such as speakers, text to voice devices, screen braille communicators or the like. Communication and data exchanged between the banking institution 110 and the customers 140 may be facilitated via the server 120 over one or more networks 150, such as the Internet, an intranet, a private network, any combination or the like. In this respect, the server 120 and the various communication devices 145 are configured to communicate with one another, with the server 120 able to provide various on-line services accessible to the customers 140 via the various communication devices 145. Additionally, the banking institution 110 via the at least one server 120 may be in communication with one or more other servers or entities, including, but not limited to, other banking institutions, vendors, and the like (not shown). The communication may be over the network 150 or through other networks (not shown) and may be facilitated by the communication interface elements. The communication between the banking institution 110 (i.e., the at least one server 120) and the other servers and entities may serve to facilitate communication between the one or more customers 140 and the other servers and entities. In addition, although not shown, the banking institution 110 and/or the other servers and entities may also include one or more remote devices, similar to remote devices 145, in order for personnel or other individuals to interact over system 100, such as to communicate with the customers 140 or to access any user accounts. The various aspects and features of the system 100, including as provided by the banking institution 110, as well as any of the one or more networks 150, the one or more remote devices 145, the at least one server 120, the one or more processing devices 122, the one or more memory devices 124, and the database 130 may be provided by hardware, software, or any combination of hardware and software, where desired.

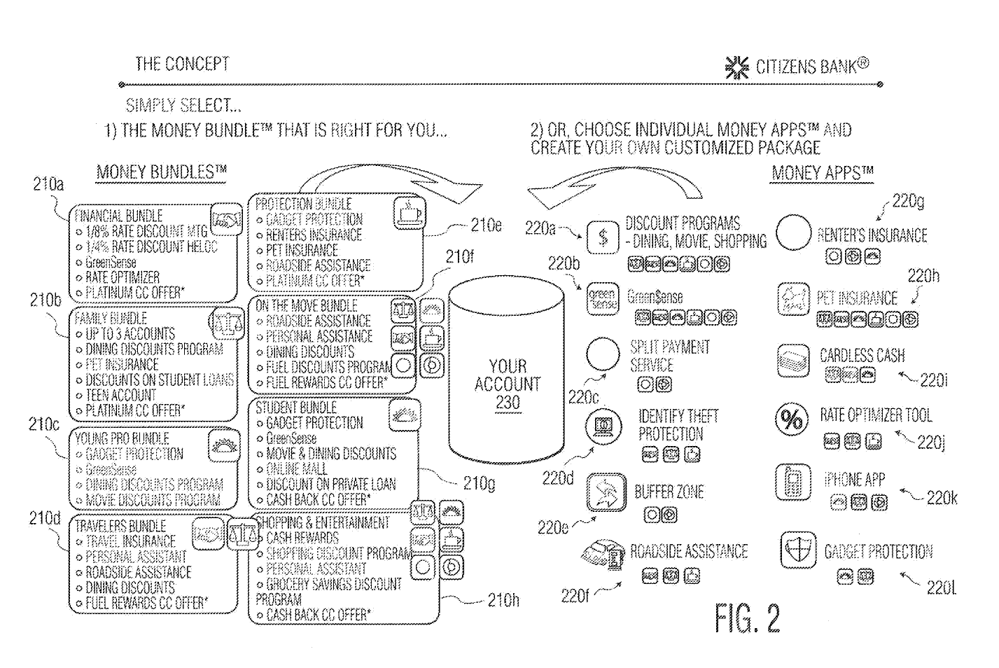

With reference to FIG. 2, a representation of data maintained by the at least one server 120 is provided. The server 120 maintains one or more pre-established packages 210 and one or more applications 220, with each pre-established package 210 providing a group of services and each application 220 providing a specific service. The group of services provided by a pre-established package 210 may correspond to a group of applications, such as one or more of the applications 220. The pre-established packages 210 of services may correspond to respective categories, such as but not limited to financial, family, youth, travel, protection, transportation, student, and entertainment, for example. Examples of pre-established packages 210 include a financial package 210a with services related to discount rates and a rate optimizer; and a student package 210g with services related to entertainment discounts and cash back offers. Examples of applications 220 includes a discount program application 220a and an identify theft protection application 220d. There are no limits to the types or number of the pre-established packages 210 and the applications 220 that may be maintained by the server 120. Moreover, there are no limits as to the particular services themselves. Data representing the one or more pre-established packages 210 and the one or more applications 220 may be stored in the database 130.

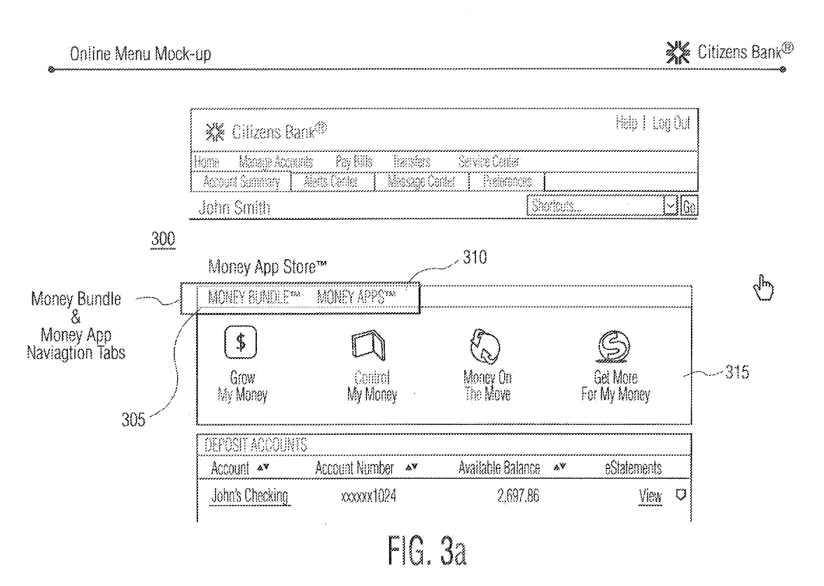

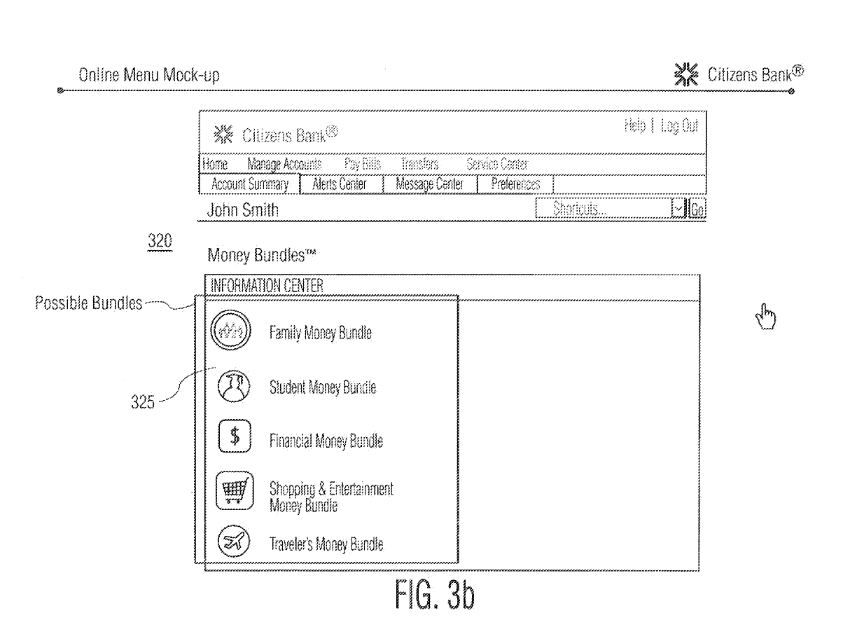

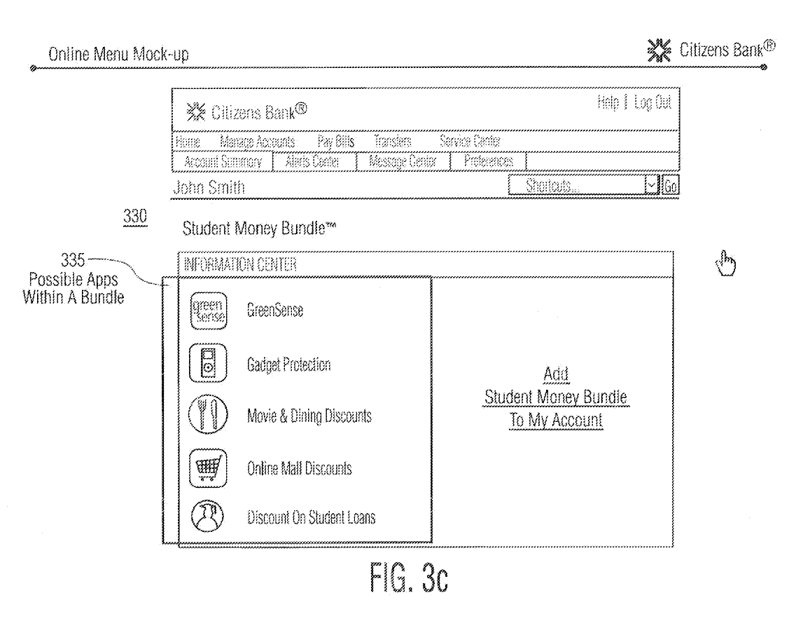

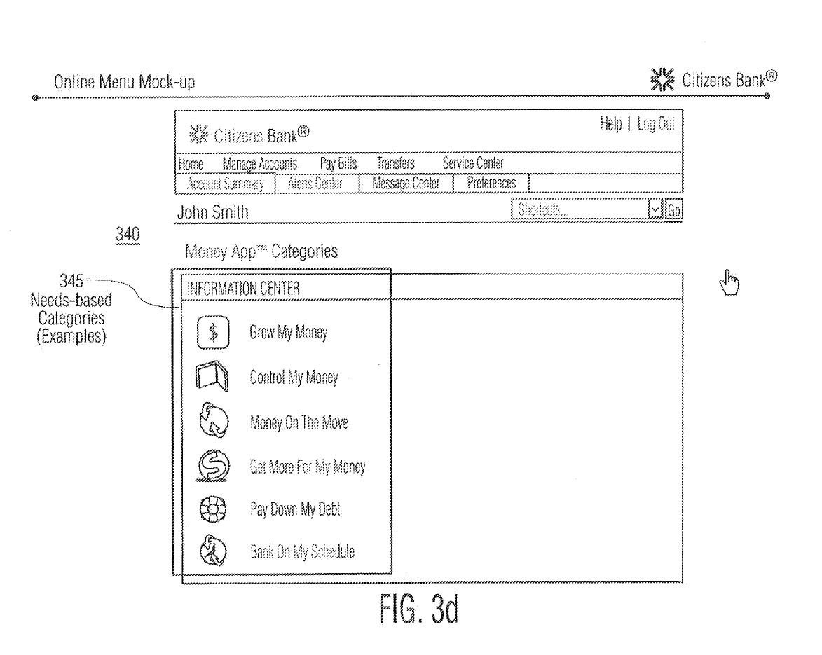

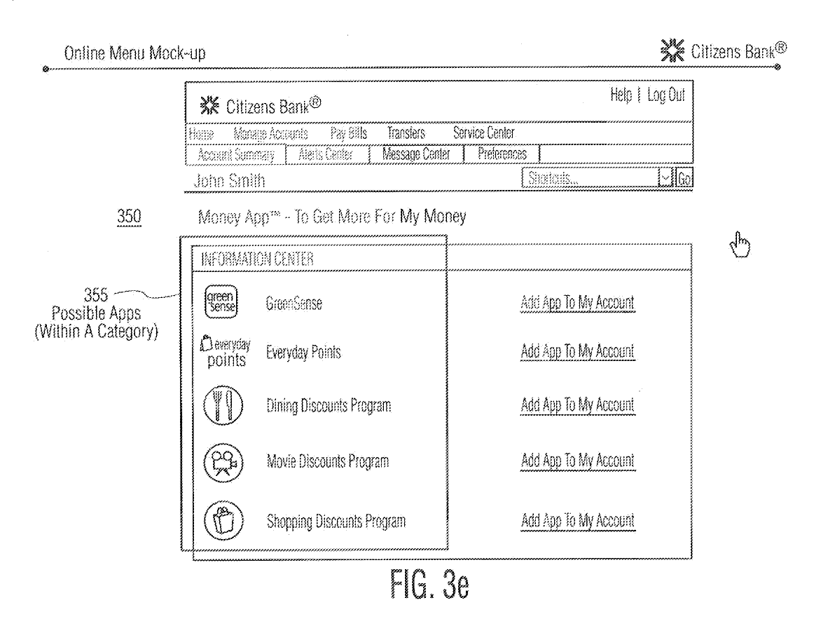

FIGS. 3a-3e are examples of graphical user interfaces (GUIs), as may be provided via the output interface of the one or more remote devices 145, as an example, in order for providing a representation of available services in the form of pre-established packages 210 and applications 220 accessible by a customer 140. FIG. 3a illustrates an example interface 300 in which services related to “money” are shown with a tab 305 to select pre-established money packages and a tab 310 to select money applications. Related service categories 315 are also provided.

An example interface 320, as shown in FIG. 3b, provides a window 325 indicating pre-established money packages, while an example interface 330, as shown in FIG. 3c, provides a window 335 indicating the services within a particular one of the pre-established money packages, in this case a “Student Money” package. For example, a customer 140 may select an icon corresponding to the “Student Money” package from the window 325 of interface 320 (FIG. 3b), which may result in the interface 330 showing the associated services (GreenSense, Gadget Protection, etc.) in the window 335.

FIG. 3d illustrates an example interface 340 containing a window 345 that indicates service categories, and FIG. 3e illustrates an example interface 350 containing a window 355 that indicates applications within a particular service category. For example, a customer 140 may wish to be provided with a listing of applications within a certain type of category. By selecting a particular category in the window 345, the user is presented with a corresponding list of applications. In the example interfaces 340, 350 shown, categories related to money are shown in window 345 (FIG. 3d), and upon selection of an icon corresponding to the “Get More for My Money” category, related applications (GreenSense, Everyday Points, etc.) are provided in window 355 (FIG. 3e).

With further reference to FIG. 2, in addition to the packages 210 and the applications 220, the server 120 also maintains at least one user account 230, with each user account 230 associated with a particular customer 140. Data representing the one or more user accounts 230 may be in the form of a respective account registry that indicates corresponding account information and customer information, where the account registries may be stored in the database 130.

Each user account 230 is associated with one or more services, such as the services that are defined by the one or more pre-established packages 210 and the one or more applications 220. To that end, the server 120 operates to process a selection request received from a remote device 145, such as made via the input interface of the one or more remote devices 145 by the customer 140, to designate at least one of the one or more pre-established packages 210 and the one or more applications 220 to a specified account 230 associated with the customer 140. With the selection request identifying the desired one or more pre-established packages 210 and/or the one or more applications 220, the server 120 operates to store the specified account 230 associated with the customer 140 to incorporate into the specified account 230 the identified services. The specified account 230 may be stored in the database 130.

In addition to processing a selection request designating services for a specified account 230, the server 120 may process a create request from the customer 140, such as made via the input interface of the one or more remote devices 145 by the customer 140, to create the specified account 230 associated with the customer 140. The processing of the create request may occur prior to or in parallel with the processing of the selection request. In addition to processing such a create request, the server 120 may also store the specified account 230 in, for example, the database 130.

The server 120 may also process information related to features of the specified account 230 and/or actions by the customer 140 with respect to the specified account 230 to make a recommendation for the customer 140 on one or more pre-established packages 210 and/or one or more applications 220. The server 120 may provide an indication to the customer 140 of the determined recommended pre-established packages 210 and/or applications 220. The server 120 may send a message, such as a text message, voicemail, or email message, as an example, with the recommended information, and which may be retreived by the customer via the output interface of the one or more remote devices 145. Alternately or additionally, the recommended information may be presented to the customer 140 via a GUI accessed by the customer 140 when viewing account information related to the specified account 230, and again as may occur via the output interface of the one or more remote devices 145.

Another type of request that may be processed by the server 120 is a customization request. The customization request may be provided from the customer 140 via the input interface of the one of the remote devices 145 and is a request to customize a portion of the services associated with the specified account 230. For example, a customization request may indicate that the customer 140 wishes to remove certain specified applications 220 that are currently associated with the specified account 230. Similarly, a customization request may serve as an indication to add applications 220 to the specified account. The customization request may also be related to the pre-established packages 210 currently associated with the specified account 230, such as removing and/or adding certain services from or to one or more of the pre-established packages 210. The customization request provides a way for the customer 140 to edit their specified account 230 in such a manner as desired by the customer 140 to include desired services and to remove services that are not of interest.

The server 120 also operates to create a display file that serves as a summary of the services associated with a specified account 230. The display file is accessible to and viewable or otherwise accessible by the customer 140 via the output interface of a remote device 145 through a log-in, which may be a secure log-in, with the server 120 at the remote device 145. The display file may also be provided to the customer 140 in a message from the server 120, such as an email message. Further details related to viewing the services associated with a specified account 230 of the customer 140 are provided below.

With respect to actually providing the services themselves (i.e., providing identity theft protection identified in the “Identity Theft Protection” application 220d), the server 120 may provide all or a portion of the services associated with the specified account 230. The server 120 may utilize vendors for providing one or more of the services, while still maintaining information related to the one or more vendor-provided services with the specified account 230. In this manner, the server 120 may act as an aggregation point for a variety of provided services, including vendor-provided services.

The one or more processing devices 122 in the system 100 of FIG. 1 may operate to provide one or more GUIs that enable customers 140 of a banking institution 110 to build, customize, and view user accounts 230. The GUIs may be associated with the various requests and features described above as performed by the server 120, such as a selection request, a create request, a customization request, and a recommendation feature.

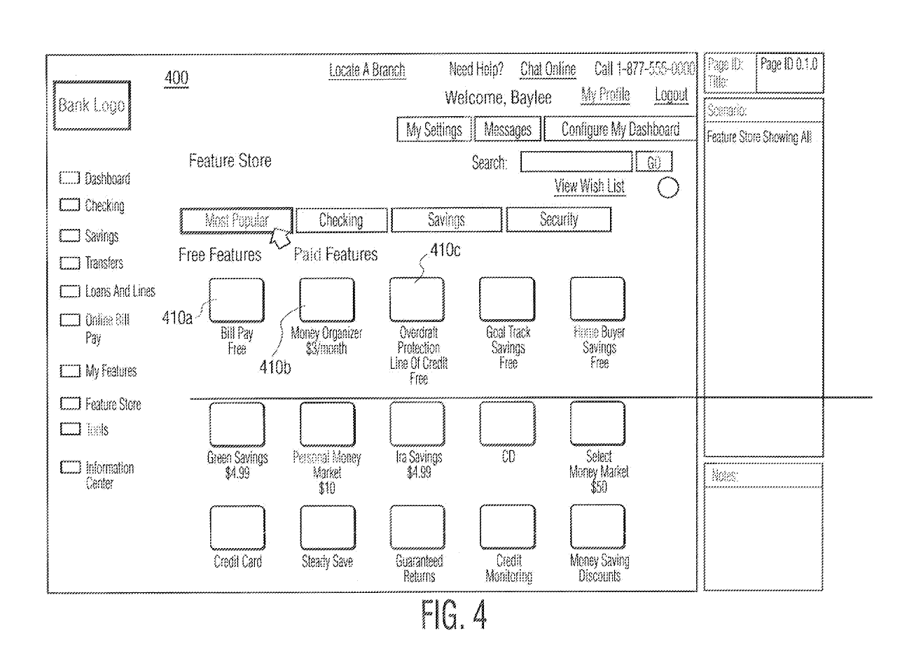

Turning now to FIG. 4, a selection GUI 400, as provided by the one or more processing devices 122, is shown. The selection GUI 400 may be viewed as a type of service store that presents various services available for a customer 140. The selection GUI 400 includes one or more service icons 410, with each service icon 410 being associated with a respective service. The selection GUI 400 is presented to the customer 140 through the output interface of the one or more of the remote devices 145, and the service icons 410 are selectable by the customer 140 via the input interface to associate the respective services with a specified account 230 with the customer 140. For example, if the customer 140 selects service icon 410a, “Bill Pay,” this service then becomes part of the services provided to the customer 140 of the specified account 230. A service icon 410 may be associated with a respective pre-established package 210 of services. Alternately, a particular service icon 410 may correspond to a respective application 220.

The selection GUI 400 may include additional features, such as tabs 420 to narrow down the number of the service icons 410 displayed on the selection GUI 400. For example, selection of a “Most Popular” tab 420a will result in those service icons 410 that are associated with the most popular services being displayed.

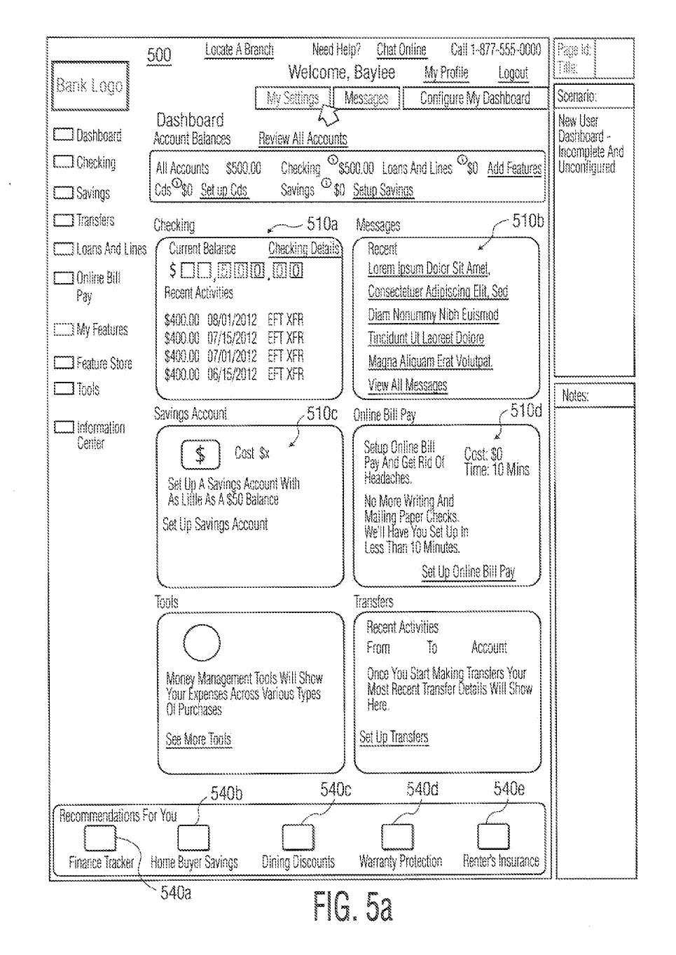

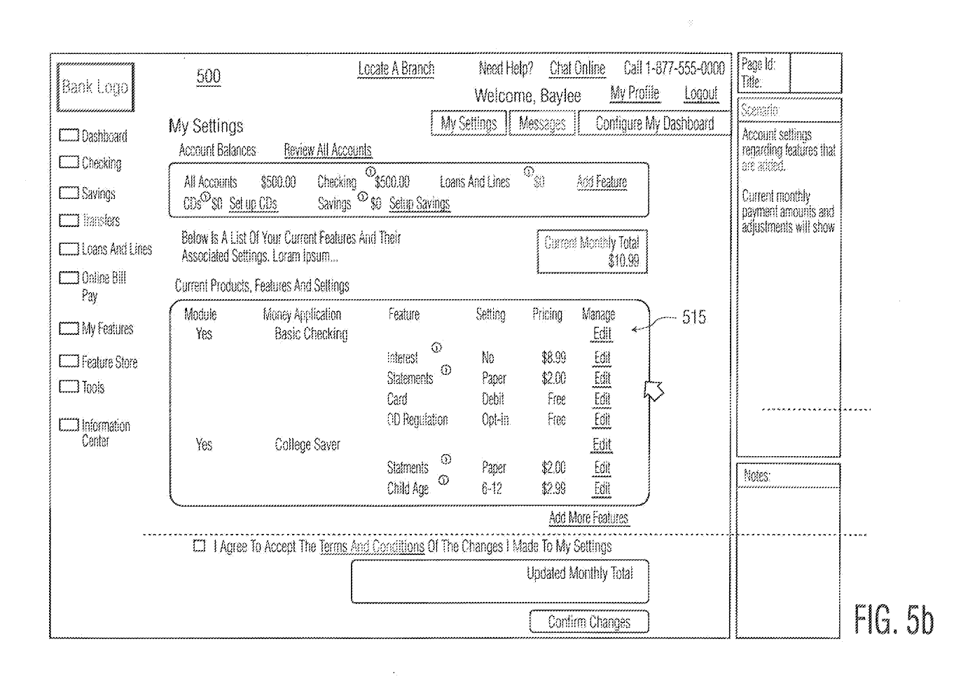

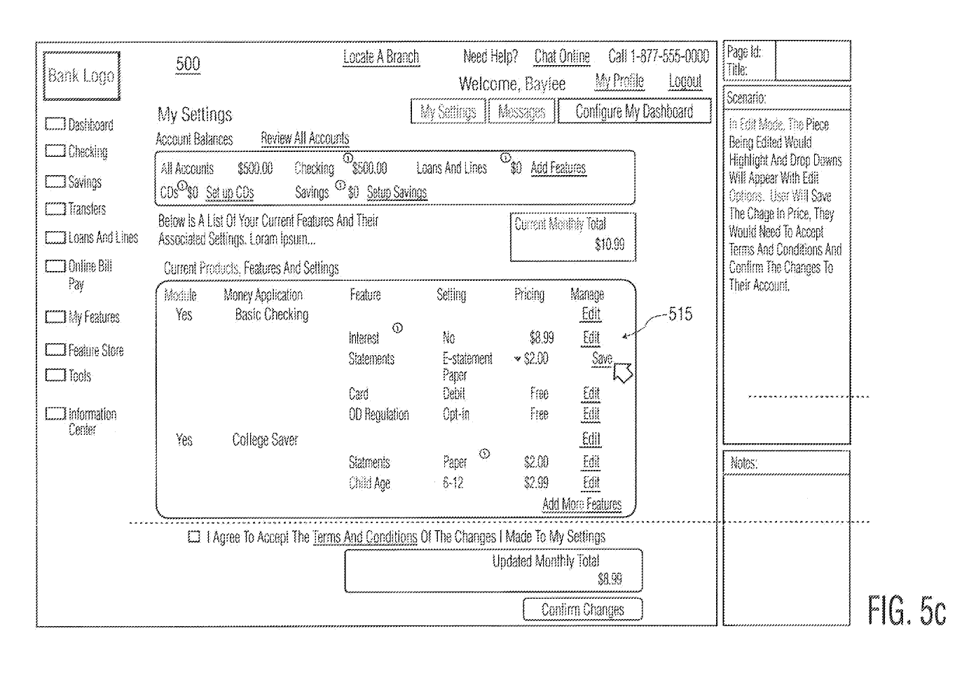

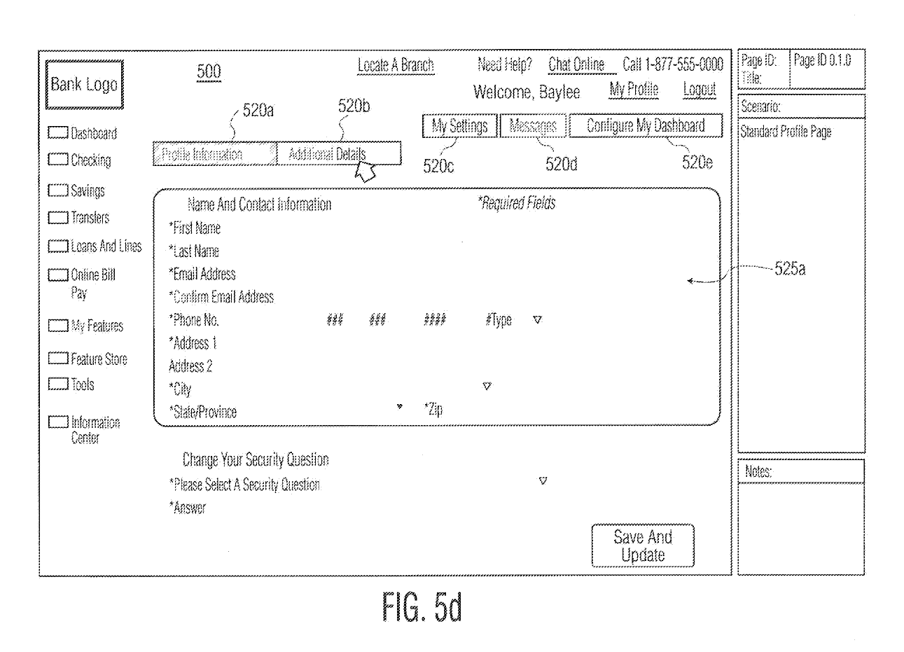

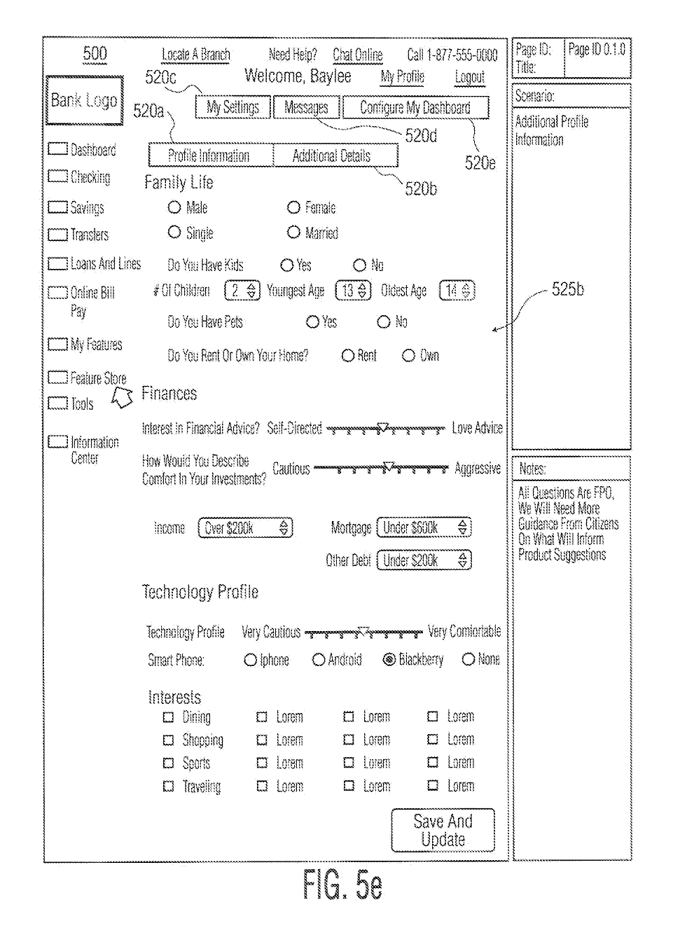

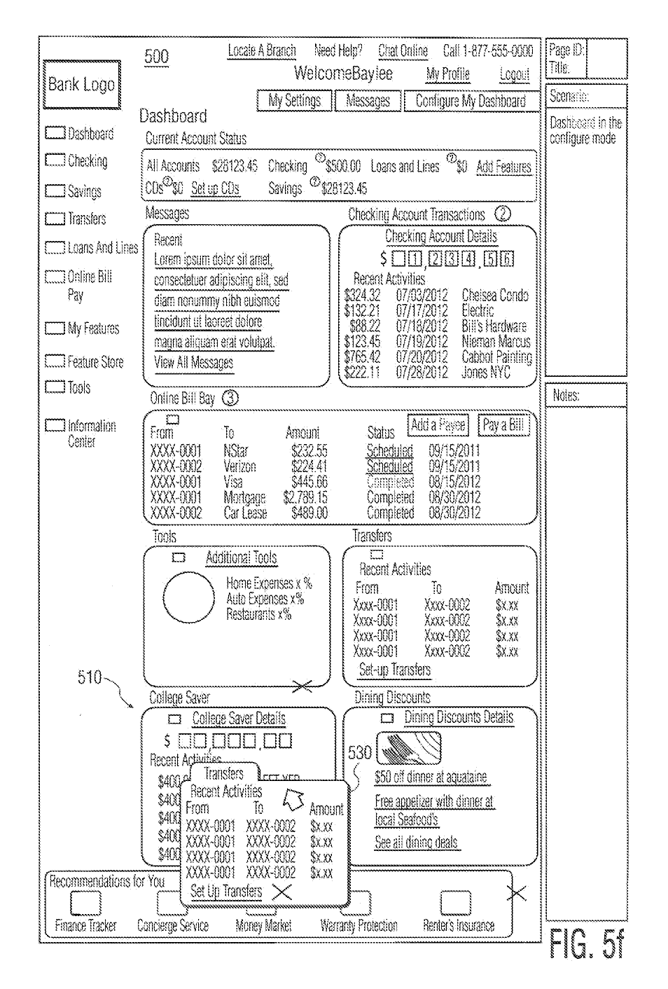

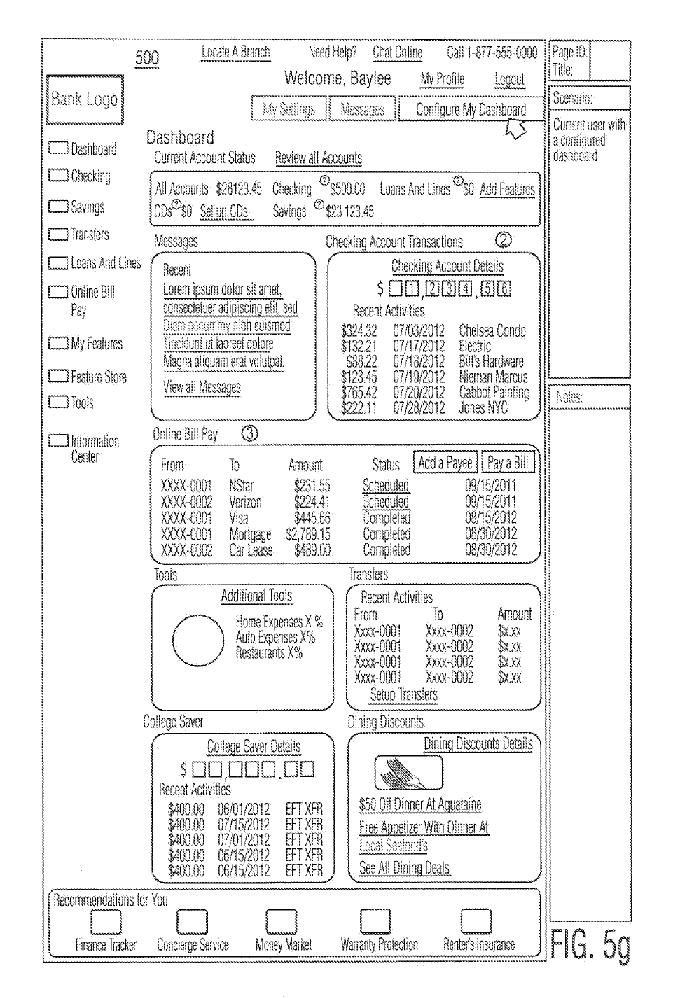

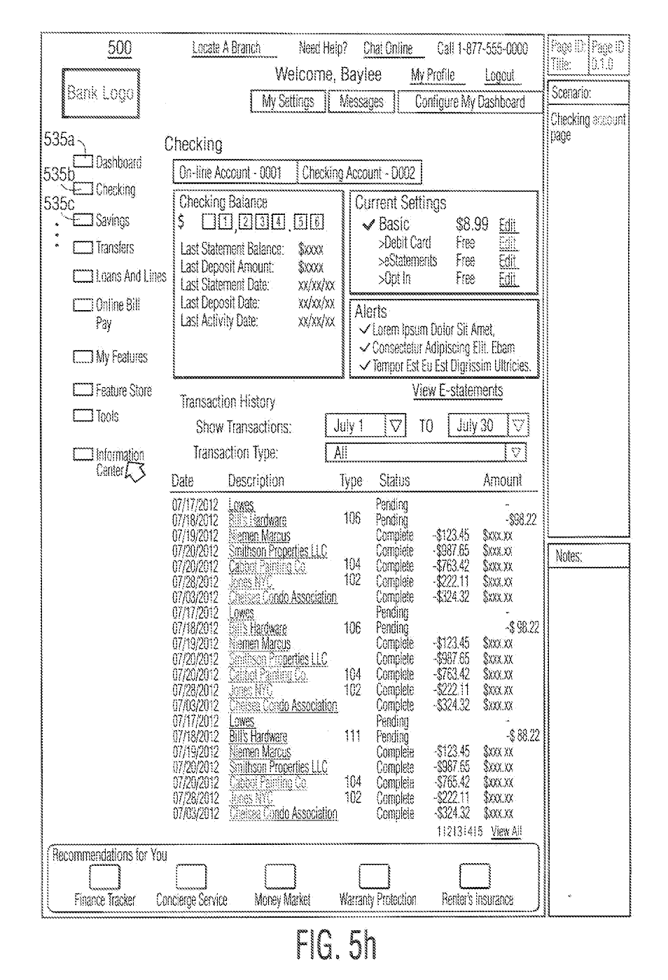

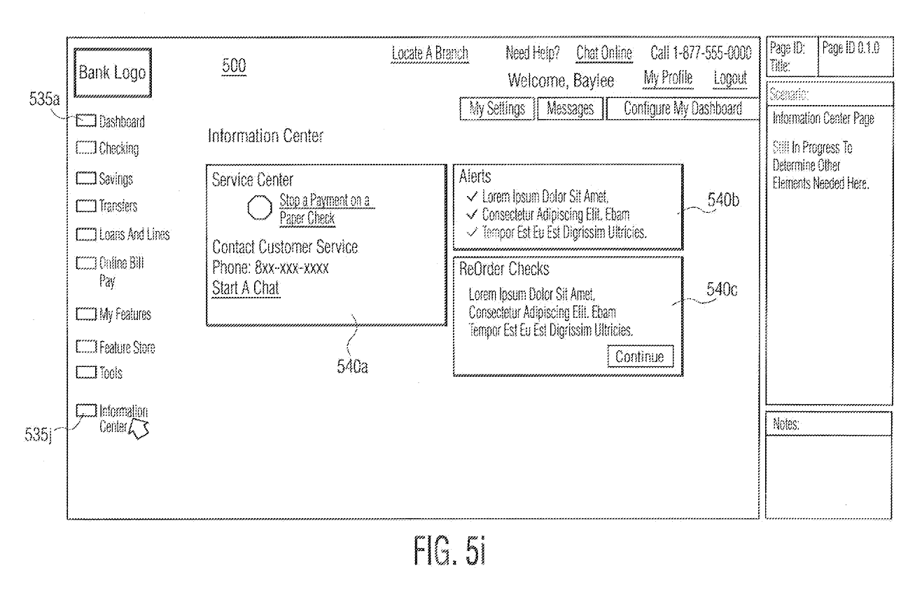

A customization GUI 500 and its various features, as may be provided by the one or more processing devices 122, are illustrated in FIGS. 5a-5i. The customization GUI 500 includes one or more service windows 510, with each service window 510 corresponding to a respective service icon 410 (in the selection GUI 400) selectable by the customer 140 via the input interface of the one or more remote devices 145 for association with the specified account 230 that is associated with the customer 140. If a service icon 410 is associated with a respective pre-established package 210, then each service in the particular pre-established package 210 may be associated with a respective service window 510. Each service window 510 includes an overview summary of the respective service. Moreover, each service window 510 is itself selectable to view and edit features of the respective service.

As an example of the service icons 410 and the related service windows 510, in FIG. 4 a service icon 410a is associated with a “Bill Pay” service. Selection of the service icon 410a in the selection GUI 400 results in a respective service window “Online Bill Pay” 510d in the customization GUI 500. Within the “Online Bill Pay” service window 510d, a summary of the “Bill Pay” service features is provided. Moreover, the “Online Bill Pay” service window 510d may be selected to view and edit features related to this service.

Some of the service windows 510 in the customization GUI 500 may contain incomplete information or incomplete information fields, indicating that the customer 140 may be required to edit and/or provide information to complete selection and establishment of the respective services. For example, the “Online Bill Pay” service window 510d indicates that the service still needs to be configured with respective customer information.

FIG. 5b illustrates the customization GUI 500 with a service edit interface 515 that is generated in response to a selection of a service window 510 that allows for viewing and editing features of a respective service associated with the selected service window 510. The service edit interface 515 in FIG. 5b corresponds to a “Checking” service window 510a. Other services may also be incorporated into the service edit interface 515. For example, in the service edit interface shown in FIG. 5b, a “College Saver” service is also provided.

FIG. 5c illustrates how the service edit interface 515 is used to view and edit features of a service. For example, the “Statements” feature has been edited to include E-statements as well as paper statements. This change, once saved by the customer 140, will be associated with the specified account 230 of the customer 140.

The customization GUI 500 may also include one or more account information tabs 520, as illustrated in FIG. 5d. An account information tab 520 corresponds to a respective account information window 525 that provides information related to the specified account 230 of the customer 140. The account information tabs 520 may be selectable by the customer 140 via an input interface of the one or more remote devices 145 to view and edit account information associated with the specified account 230. By way of example, “Profile Information” account information tab 520a, when selected, provides an overview of information related to the customer 140 in account information window 525a. The customer 140 is able to edit and update the information provided upon selection of the tab 520a. Similarly, as shown in FIG. 5e, selection of “Additional Details” account information tab 520b provides a corresponding account information window 525b, detailing and allowing for edits related to additional information of the customer 140.

FIG. 5f provides a representation of the customization GUI 500 with a pop-up window 530 generated in response to a selection of a respective service window 510 that allows for viewing and editing features of a respective service associated with the selected service window 510.

FIG. 5g is a representation of the customization GUI 500 after the customer 140 has edited and provided information on the various services associated with the specified account 230. Such a representation may be the result of the customer 140 utilizing the various service edit interfaces 515, account information tabs 520, account information windows 525, and pop-up windows 530.

The customization GUI 500 may also include one or more service tabs 535, as shown in FIG. 5h. A service tab 535 may correspond to a respective service window 510, which in turn corresponds to a respective service icon 410 from the selection GUI 400. Alternately, a service tab 535 may provide additional information not specifically related to a particular service. Each of the service tabs 535 is selectable to view and edit features of the respective service. “Checking” service tab 535b is shown to be selected in FIG. 5h, with information related to the checking account of the customer 140 displayed. In FIG. 5i, “Information Center” service tab 535j is shown to be selected, resulting in various related information windows 535 being displayed in the customization GUI 500.

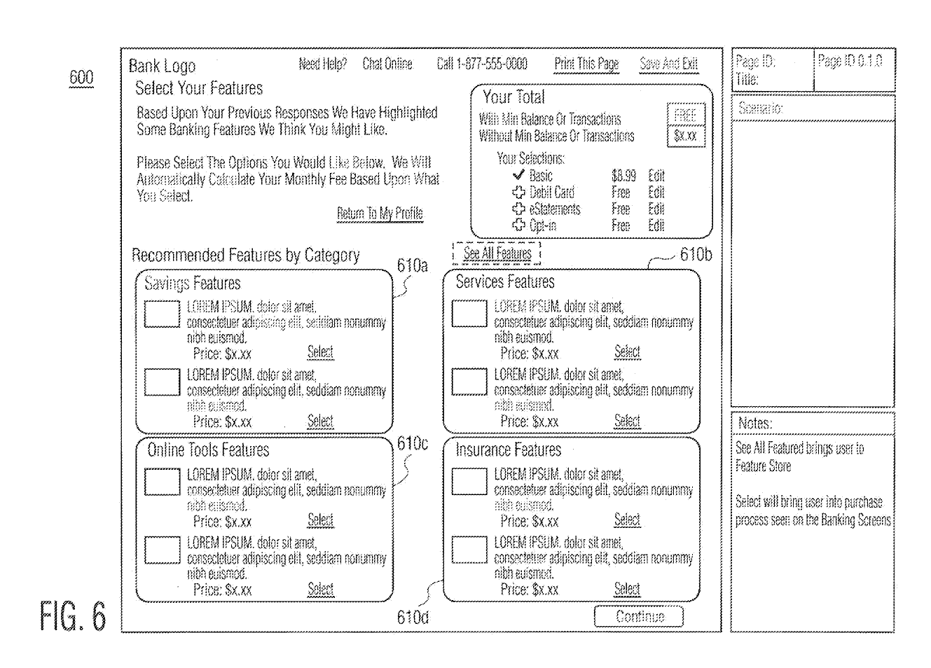

FIG. 6 is an example recommendation interface 600 for viewing recommended account features for a specified account 230. As described above with respect to processing performed by the server 120 (and the one or more processing devices 122), information related to features of the specified account 230 and/or actions by the customer 140 with respect to the specified account 230 may be processed to make a recommendation for the customer 140 on one or more pre-established packages 210 and/or one or more applications 220. The recommendations are presented in the form of recommended service icons 610 that may include information, such as a brief overview, of the respective recommended services. In addition to displaying the recommended service icons 610 in the recommendation interface 600, second recommendation service icons 540 may be presented in a portion of the customization GUI 500, as shown in FIG. 5a. From either the recommendation interface 600 or the customization GUI 500, the customer 140 may select the icons 610, 540 to receive more information about the respective services (i.e., in a pop-up window) or to select the respective services to associate the respective services with the specified account 230.

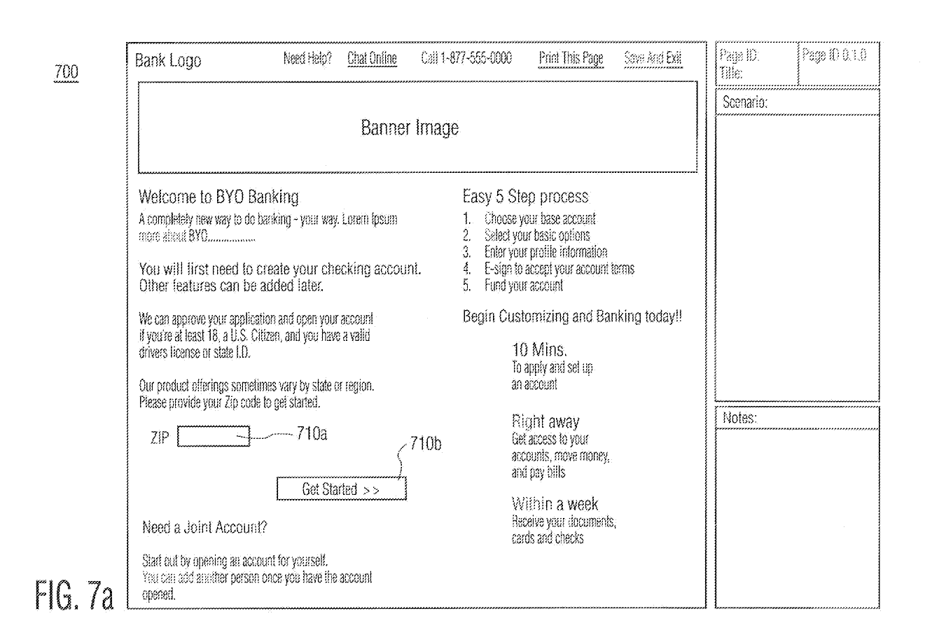

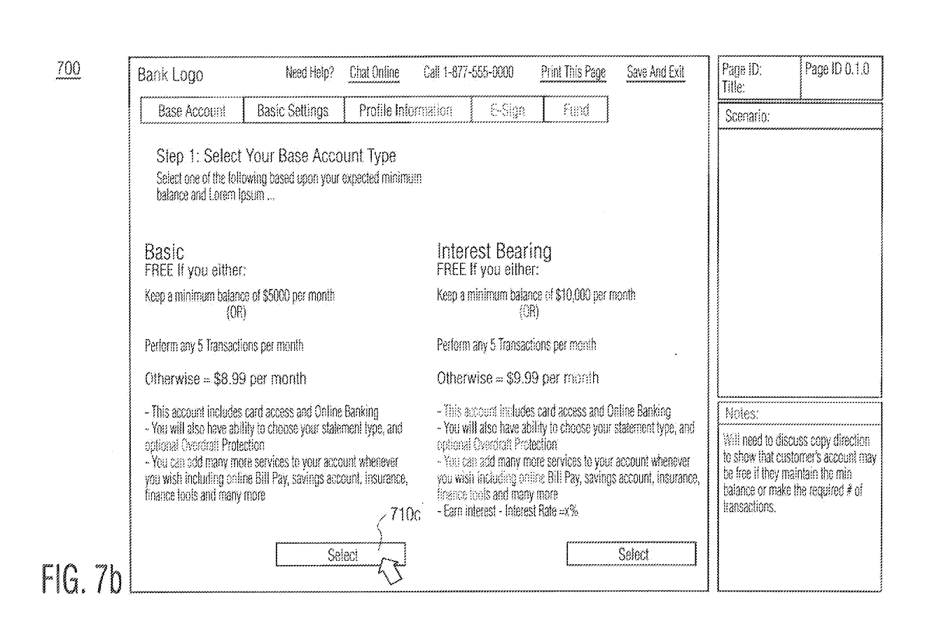

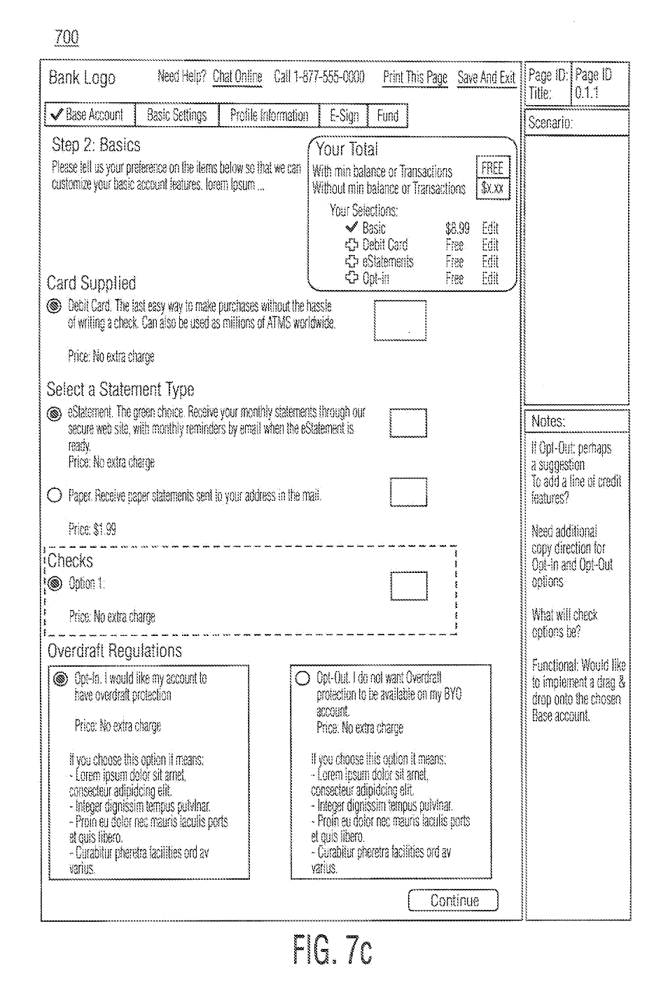

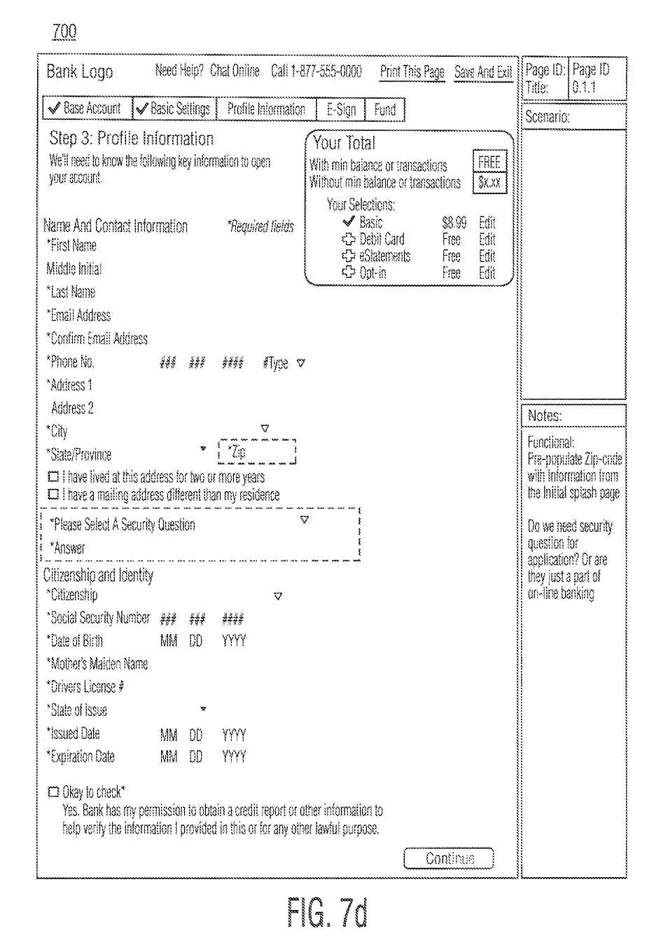

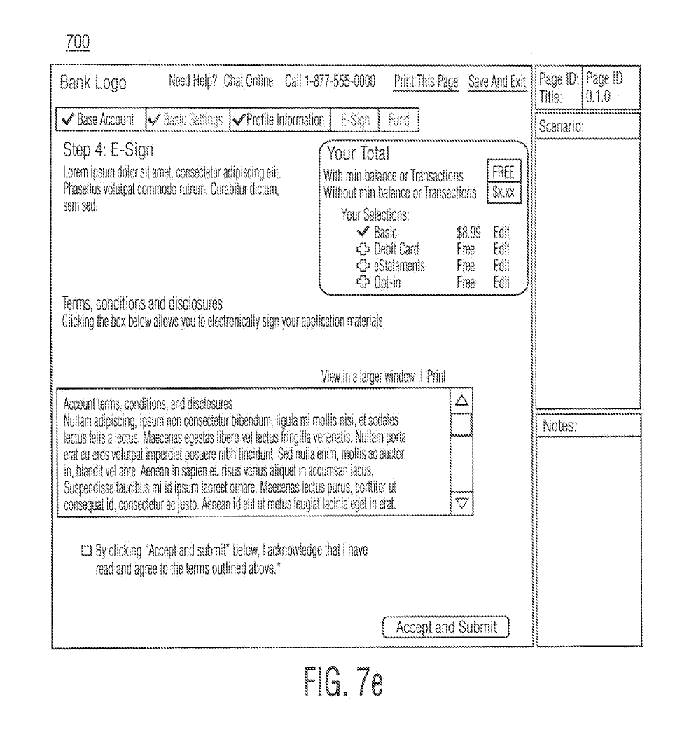

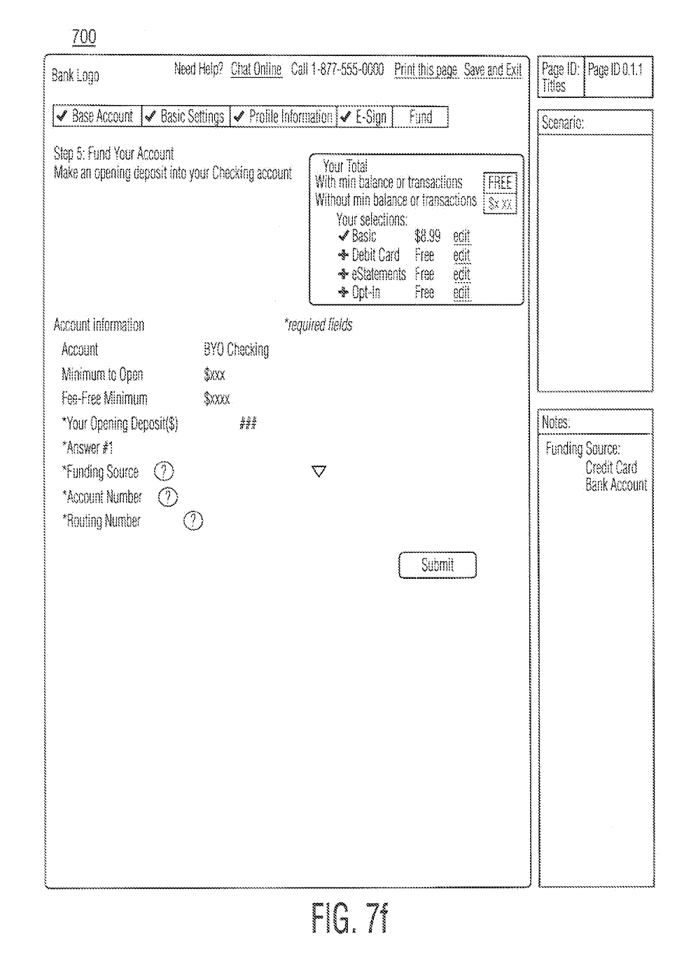

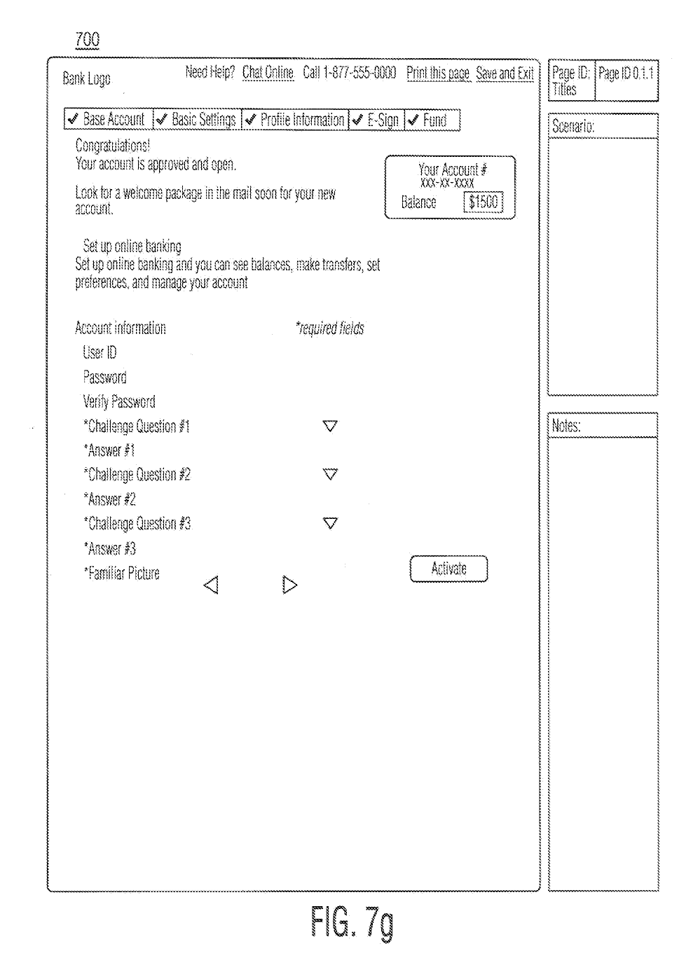

FIGS. 7a-7g are example account creation interfaces 700. As described above with respect to the create request processed by the server 120, a create request from the customer 140 made via the input interface of the one or more remote devices 145 is utilized to establish the specified account 230 associated with the customer 140. The processing of the create request, via the account creation interface 700, may typically occur prior to, or in some instances in parallel with, use of the customization GUI 500. The account creation interface 700 includes one or more fields 710 for identifying or selecting desired features of the specified account 230. For example with reference to FIG. 7a, a “Zip Code” field 710a is provided. Completion of at least one of the fields 710 results in the processing devices 122 generating additional fields for further information to be provided or identified relevant to the specified account 230. For example, once the customer 140 enters a zip code in the field 710a shown in FIG. 7a, the account creation interface 700 progresses to FIG. 7b, in which additional information related to the desired account is requested. The fields 710 may be an icon, such as 710c shown in FIG. 7b. Selection of 710c results in the account creation interface 700 shown in FIG. 7c. The account creation interfaces 700 in FIGS. 7a-7g each portray a progression of the account creation for the specified account 230.

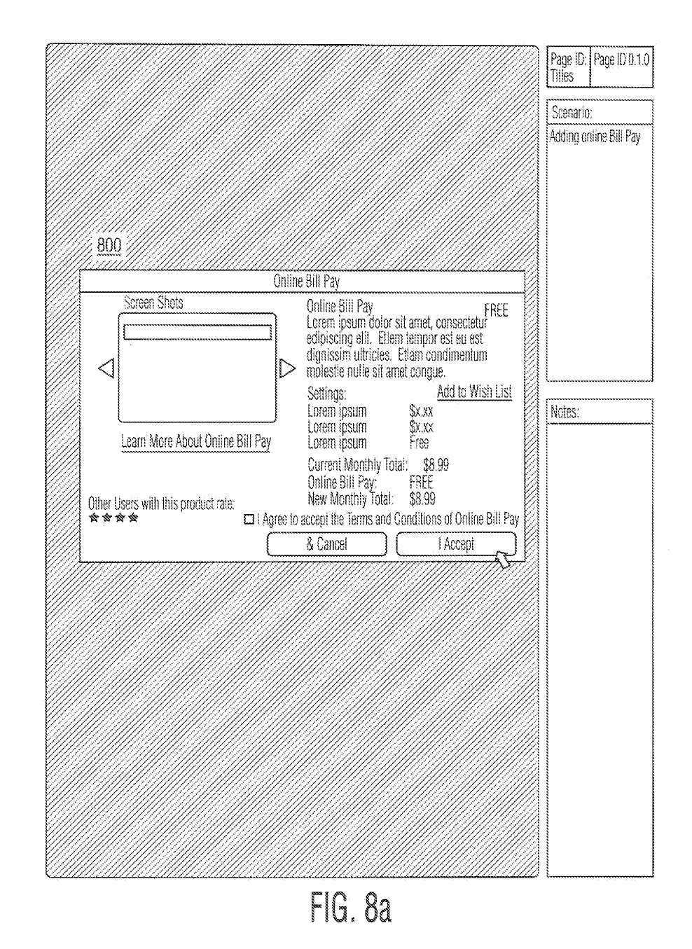

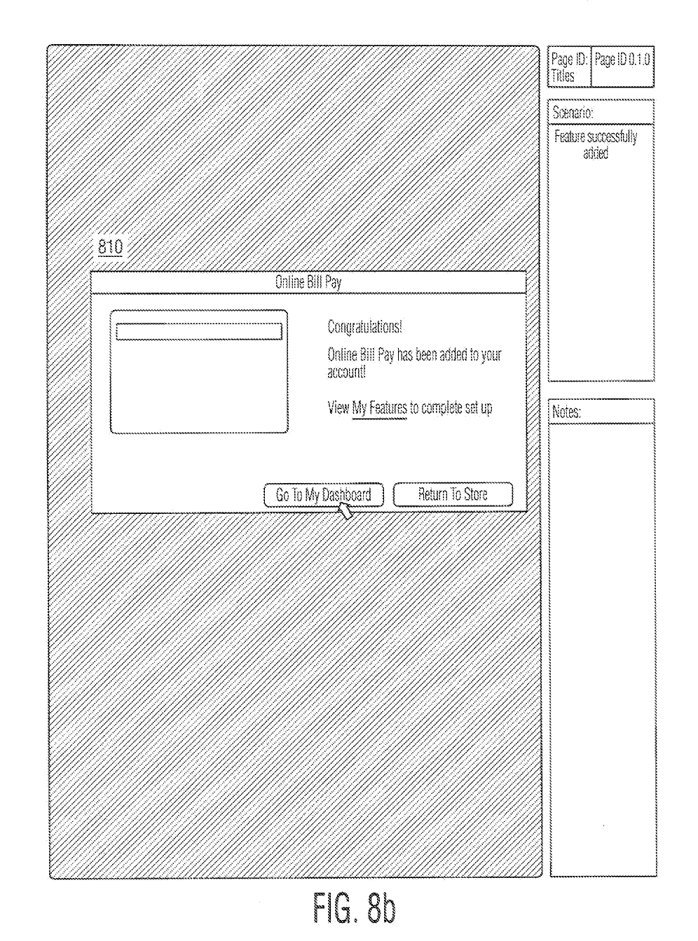

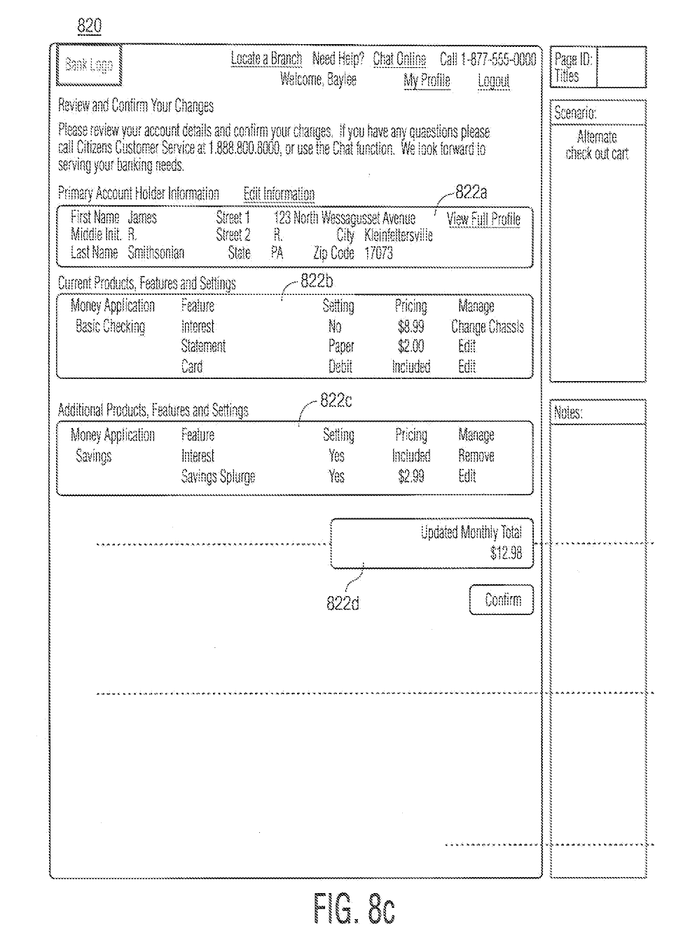

FIGS. 8a-8c illustrate verification interfaces 800, 810, and 820 for verifying and identifying selected account features. For example, selection of the “Online Bill Pay” service window 510d shown in FIG. 5a may result in a series of the verification interfaces 800, 810, and 820. The verification interface 800 may contain information relevant to the selected service to ensure that the customer 140 agrees to the terms, as shown in FIG. 8a. As shown in FIG. 8b, the verification interface 810 may include a message informing the customer 140 that the selected service has been added to the specified account 230. Additionally, the verification interface 820 may provide a series of windows 822 that serve as an overview of the selected service. Each verification interface 800, 810, and 820 may also include options for editing the services associated with the specified account 230.

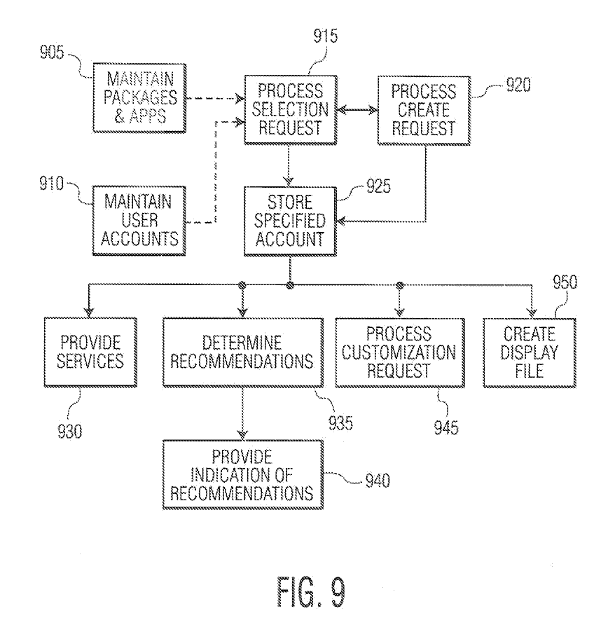

FIG. 9 is a flowchart illustrating a method for enabling a customer 140 to maintain and customize a user account with a banking institution, such as the banking institution 110 shown in FIG. 1. At 905, at least one of one or more pre-established packages 210 and one or more applications 220 are maintained at the at least one server 120. As described above, each pre-established package 210 provides a group of services and each application 220 provides a specific service to be associated with a specified account 230 of a customer 140.

At 910, one or more user accounts are maintained at the at least one server 120. Each user account is associated with a particular customer 140, with each user account being linked to a respective account registry, which may be stored in the database 130, indicating corresponding account information and customer information. Moreover, each user account is associated with one or more services, such as the services that are part of the pre-established packages 210 and the applications 220.

At 915, the at least one server 120 processes a selection request from a customer 140 to designate at least one of the one or more pre-established packages 210 and the one or more applications 210 to a specified account 230 associated with the customer 140. At 920, the specified account 230 associated with the customer 140 is stored by the at least one server 120. The specified account 230 may be stored in a memory component 124 of the server 120 or in the database 130 associated with the banking institution 110.

The at least one server 120 associated with the banking institution 110 thus operates to associate services in pre-established packages 210 and applications 220 with a specified account 230 of the customer 140, while also maintaining the pre-established packages 210 and applications 220. This enables customers 140 of the banking institution 110 to maintain and customize user accounts.

At 920, the at least one server 120 processes a create request from the customer 140 to create the specified account 230 that is associated with the customer 140. To create the specified account 230, the customer 140 may, for example, utilize the various account creation interfaces 700 described above with respect to FIGS. 7a-g. The processing of the create request, at 920, may occur in parallel with the processing of the selection request at 915. Alternately, one of the processing steps (processing the selection request 915, processing the create request 920) may occur prior to the other. For example, a customer 140 may initiate a selection request to be processed by the server 120 prior to establishing an account with the banking institution. The initiation of the selection request may then prompt the server 120 to request that the user establish an account via, for example, a create request or other means. That is, the customer 140 may set up a specified account 230 in person at the banking institution 110, at an affiliated branch, over the telephone, or via messaging such as email, for example. Alternately, the customer 140 may first establish the specified account 230 prior to initiating a selection request to be processed by the server 120.

At 925, the specified account 230 is stored at the at least one server 120 in, for example, the database 130.

Following the establishing and storing of the specified account 230 by the at least one server 120 for the customer 140, various types of processing may occur to allow the customer 140 to take advantage of services provided by the banking institution and to further customize the specified account 230. At 930, for example, the at least one server 120 may provide at least a portion of the services associated with the specified account 230. Thus if a customer 140 wants to utilize a rewards program that has been associated with the speci lied account, the at least server 120 may disseminate appropriate gift cards or shopping vouchers, for example. The at least one server 120 may, in addition, utilize outside vendors to complete some aspects of the services.

At 935, as an additional processing feature, the at least one server 120 may determine at least one of a recommended pre-established package and a recommended application from the one or more pre-established packages 210 and the one or more applications 220 for the customer 140. The recommendations may be based on features of the specified account 230 and/or actions by the customer 140 with respect to the specified account 230. For example, the server 120 may note interests of the customer 140 through the customer's use of services that are already associated with the customer's specified account 230. This may lead the at least one server 120 to recommend a similar application 220 or a pre-established package 210.

At 940, after the determination of recommendations is complete, the at least one server 120 processes information to provide an indication to the customer 140 of the recommended pre-established packages and/or applications. The server 120 may send a message, such as an email message, voicemail message, or text message, to the customer 140. The recommendations may also be presented to the customer 140 as recommended service icons 610, 540 in the recommendation interface 600 or the customization GUI 500 shown in FIG. 6 and FIG. 5, respectively.

At 945, as an additional processing feature, the at least server 120 may process a customization request from the customer 140 to customize a portion of the services associated with the specified account 230. The customization request may indicate certain services to be removed from, added to, and/or modified with respect to the specified account 230.

At 950, the at least one server 120 creates a display file that summarizes the services associated with the specified account 230. The display file is accessible to and viewable by the customer 140 at a remote station, such as one of the customer devices 145. The display file may be accessible through a secure log-in with the server 120. The display file may be the customization GUI 500, such as that in FIGS. 5a-5i, that includes service windows 510 that provide an overview of services associated with the specified account 230.

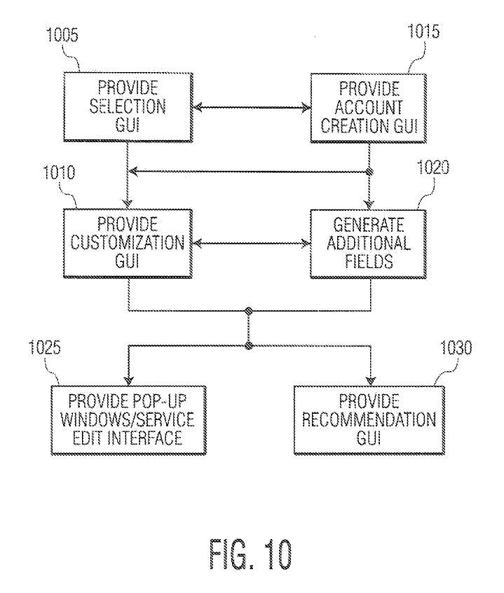

FIG. 10 is a flowchart illustrating a method of providing one or more graphical user interfaces (GUIs) that enable customers 140 of a banking institution 110 to build, customize, and view accounts. The one or more processing devices 122 may implement the method.

At 1005, a selection GUI 400 including one or more service icons 410, with each service icon 410 being associated with a respective service, is provided. At least one of the service icons 410 is selectable by a customer 140 to associate the respective services with a specified account 230 associated with the customer 140.

At 1010, a customization GUI 500 that is based on selections in the selection GUI is provided. The customization GUI 500 includes one or more service windows 510, each corresponding to a respective service icon 410 selectable by the customer 140 for association with the specified account 230. Each service window 510 includes an overview summary of the respective service, and each service window 510 is selectable to view and edit features of the respective service. The customization GUI 500 may also include such features including one or more service tabs 535 and one or more account information tabs 520, each of which may be selectable to view and edit respective service and account information.

At 1015, an account creation GUI, such as the account creation interfaces 700, is provided. The account creation GUI is used to establish the specified account 230 and includes one or more fields 710 for identifying desired features of the specified account 230. The account creation GUI may be provided in parallel with the selection GUI at 1005. Alternately, one may be provided prior to the other.

At 1020, in response to completion of at least one field 710 in the account creation GUI, additional fields 710 may be generated to provide further information related to the specified account 230. In this manner, the customer 140 is able to provide relevant and requested account information in order to set up a customer account with the banking institution 110.

Additional features may be provided by the processing device 122 to enhance the ability of the customer 140 to customize the specified account 230. For example, at 1025, one or more pop-up windows 530 and/or service edit interfaces 515 may be provided for viewing and editing features of a service in response to selection of a service window 510.

At 1030, as another example of further processing for the customer 140 to customize the specified account 230 or to receive options related to possible customizations, the processing device 122 provides a recommendation GUI, such as the recommendation interface 600 or a portion of the customization GUI 500. The recommendation GUI includes one or more recommended service icons, each of which are associated with a respective recommended service based on features of the specified account 230 and/or actions taken by the customer 140 with respect to the specified account 230.

Thus, the system 100 provides various features that enable a customer to maintain and customize a user account with a particular banking institution. Through pre-established packages providing a group of services and applications providing a specific service, as well as through various GUIs, the customer is able to build, customize, and view a specified account.

The foregoing examples are provided merely for the purpose of explanation and are in no way to be construed as limiting. While reference to the various examples are shown, the words used herein are words of description and illustration, rather than words of limitation. Further, although reference to particular means, materials, and examples are shown, there is no limitation to the particulars disclosed herein. Rather, the examples extend to all functionally equivalent structures, methods, and uses, such as are within the scope of the appended claims.

1. A method for enabling a customer to maintain and customize a user account with a banking institution, the method comprising:
maintaining at at least one server at least one of one or more pre-established packages and one or more applications, each pre-established package providing a group of services and each application providing a specific service;
maintaining at the at least one server one or more user accounts, each user account associated with a particular customer, with each user account linked to a respective account registry indicating corresponding account information and customer information, and each user account associated with one or more services;
processing at the at least one server a selection request from a customer to designate at least one of the one or more pre-established packages and the one or more applications to a specified account associated with the customer; and
storing at the at least one server the specified account associated with the customer to incorporate into the specified account the services identified in the selection request;
wherein each of the maintaining, processing, and storing steps are implemented by one or more processing devices, wherein the one or more processing devices accesses instructions from one or more memory devices, the instructions, when executed, causing each of the maintaining, processing, and storing steps to be implemented.

2. The method of claim 1, further comprising:
processing at the at least one server a create request from the customer to create the specified account associated with the customer; and
storing at the server the specified account.

3. The method of claim 1, further comprising:
providing by the at least one server at least a portion of the services associated with the specified account.

4. The method of claim 1, further comprising:
determining at the at least one server at least one of a recommended pre-established package and a recommended application from the one or more pre-established packages and the one or more applications for the customer based on at least one of features of the specified account and actions by the customer with respect to the specified account; and
processing information to indicate to the customer the determined at least one of the recommended pre-established package and the recommended application.

5. The method of claim 1, further comprising:
processing at the at least one server a customization request from the customer to customize a portion of the services associated with the specified account, wherein the customization request includes information on the portion of the services to be customized.

6. The method of claim 1, further comprising:
creating at the at least one server a display file summarizing the services associated with the specified account, the display file accessible to and viewable by the customer at a remote device through a secure log-in with the at least one server.

7. A system for enabling a customer to maintain and customize a user account with a banking institution, the system comprising:
at least one server configured to communicate with one or more remote devices, the at least one server comprising one or more processing devices that accesses instructions from one or more memory devices, the instructions, when executed, causing the at least one server to:
maintain at least one of one or more pre-established packages and one or more applications, each pre-established package providing a group of services and each application providing a specific service;
maintain at least one user account, each user account associated with a particular customer, with each user account linked to a respective account registry indicating corresponding account information and customer information, and each user account associated with one or more services;
process a selection request received from a remote device to designate at least one of the one or more pre-established packages and the one or more applications to a specified account associated with the customer; and
store the specified account associated with the customer to incorporate into the specified account the services identified in the selection request.

8. The system of claim 7, wherein the instructions further cause the at least one server to:
process a create request from the customer to create the specified account associated with the customer; and
store the specified account.

9. The system of claim 7, wherein the instructions further cause the at least one server to:
provide at least a portion of the services associated with the specified account.

10. The system of claim 7, wherein the instructions further cause the at least one server to:
determine at least one of a recommended pre-established package and a recommended application from the one or more pre-established packages and the one or more applications for the customer based on at least one of features of the specified account and actions by the customer with respect to the specified account; and
process information to indicate to the customer the determined at least one of the recommended pre-established package and the recommended application.

11. The system of claim 7, wherein the instructions further cause the at least one server to:
process a customization request from the customer to customize a portion of the services associated with the specified account, wherein the customization request includes information on the portion of the services to be customized.

12. The system of claim 7, wherein the instructions further cause the at least one server to:
create a display file summarizing the services associated with the specified account, the display file accessible to and viewable by the customer via a remote device through a secure log-in with the at least one server at the remote device.

13. A system comprising one or more processing devices for providing one or more graphical user interfaces (GUIs) that enable customers of a banking institution to build, customize, and view accounts, comprising:
a selection GUI comprising:
one or more service icons, each service icon associated with a respective service, wherein at least one of the one or more service icons is selectable by a customer to associate the respective services with a specified account associated with the customer;
and
a customization GUI comprising:
one or more service windows, each service window corresponding to a respective service icon selectable by the customer for association with the specified account associated with the customer, each service window comprising an overview summary of the respective service, and each service window being selectable to view and edit features of the respective service.

14. The system of claim 13, further comprising at least one of a pop-up window and a service edit interface for viewing and editing features of the respective service, and generated in response to a selection of a service window of the one or more service windows.

15. The system of claim 13, further comprising:
a recommendation GUI comprising:
one or more recommended service icons, each recommended service icon associated with a respective recommended service based on at least one of features of the specified account and actions by the customer with respect to the specified account.

16. The system of claim 13, wherein at least one of the one or more service icons is associated with a respective pre-established package of services.

17. The system of claim 16, wherein each service in a particular pre-established package of services is associated with a respective one of the one or more service windows.

18. The system of claim 16, wherein the pre-established packages of services correspond to respective categories, the categories comprising financial, family, youth, travel, protection, transportation, student, and entertainment.

19. The system of claim 13, further comprising:
an account creation GUI for establishing the specified account associated with the customer, the account creation GUI comprising:
one or more fields for identifying desired features of the specified account, wherein completion of at least one of the one or more fields results in the processing device generating additional fields for further information related to the specified account.

20. The system of claim 13, wherein the customization GUI further comprises one or more service tabs;
wherein at least one of the one or more service tabs corresponds to a respective service window corresponding to a respective service icon, wherein each of the one or more service tabs is selectable to view and edit features of the respective service.

21. The system of claim 13, wherein the customization GUI further comprises one or more account information tabs;
wherein at least one of the one or more account information tabs corresponds to a respective account information window, with each account information window providing information related to the specified account, wherein each of the one or more account information tabs is selectable to view and edit account information associated with the specified account.

22. A method of providing one or more graphical user interfaces (GUIs) via one or more processing devices that enable customers of a banking institution to build, customize, and view accounts, the method comprising:
providing a selection GUI comprising one or more service icons, each service icon associated with a respective service, wherein at least one of the one or more service icons is selectable by a customer to associate the respective services with a specified account associated with the customer; and
providing a customization GUI based on selections in the selection GUI, the customization GUI comprising one or more service windows, each service window corresponding to a respective service icon selectable by the customer for association with the specified account associated with the customer, each service window comprising an overview summary of the respective service, and each service window being selectable to view and edit features of the respective service.

23. The method of claim 22, further comprising:
providing at least one of a pop-up window and a service edit interface, in response to selection of a service window of the one or more service windows, for viewing and editing features of the respective service.

24. The method of claim 22, further comprising:
providing a recommendation GUI comprising one or more recommended service icons, each recommended service icon associated with a respective recommended service based on at least one of features of the specified account and actions by the customer with respect to the specified account.

25. The method of claim 22, wherein at least one of the one or more service icons is associated with a respective pre-established package of services.

26. The method of claim 25, wherein each service in a particular pre-established package of services is associated with a respective one of the one or more service, windows.

27. The method of claim 25, wherein the pre-established packages of services correspond to respective categories, the categories comprising financial, family, youth, travel, protection, transportation, student, and entertainment.

28. The method of claim 22, further comprising:
providing an account creation GUI for establishing the specified account associated with the customer, the account creation GUI comprising one or more fields for identifying desired features of the specified account; and
generating additional fields for further information related to the specified account in response to completion of at least one of the one or more fields.

29. The method of claim 22, wherein the customization GUI further comprises one or more service tabs;
wherein at least one of the one or more services tabs corresponds to a respective service window corresponding to a respective service icon, wherein each of the one or more service tabs is selectable to view and edit features of the respective service.

30. The method of claim 22, wherein the customization GUI further comprises one or more account information tabs;
wherein at least one of the one or more account information tabs corresponds to a respective account information window, with each account information window providing information related to the specified account, wherein each of the one or more account information tabs is selectable to view and edit account information associated with the specified account.
